(19) United States
(12) Patent Application Publication
(10) Pub. No.: US 2022/0315077 A1
(43) Pub. Date: Oct. 6, 2022

(54) One Trip Module Dolly

(71) Applicants: Juan Jimenez, Bethany, OK (US); Destiny Hatton-Jimenez, Bethany, OK (US)

(72) Inventors: Juan Jimenez, Bethany, OK (US); Destiny Hatton-Jimenez, Bethany, OK (US)

(21) Appl. No.: 17/219,552

(22) Filed: Mar. 31, 2021

(51) Int. Cl. B62B 1/12; A47B 87/02; B62B 5/06; B62B 1/26

(52) U.S. Cl. CPC B62B 1/125; A47B 87/0261; B62B 5/067; B62B 1/26; B62B 2206/02; B62B 2205/14; B62B 2202/12; B62B 2501/06

(57) ABSTRACT

The disclosure is the only product of its kind that enables users to simply organize food, gear, materials, tools and other items in one easy to access location. The disclosure is uniquely designed with a weatherproof body with protected corners and edges to guarantee impact resistance and durability; yet, provides a lightweight but tough, extendable dolly for managing different tasks. The high performance magnetic sealed pull-out drawer cooler reinvents the use of a standard cooler and includes a zip waterproof pocket on each side along with two cup holders, a bottle opener, and easy to grip handles. The disclosure includes stackable boxes, a folding tray and a telescopic adjustable height handle. The disclosure further includes a pair of retractable wheels configured to support the folding tray hinge and adjust to the width of the plurality of stackable boxes.

### BACKGROUND

Staying organized when one is spending extensive amounts of time outdoors is important for a variety of reasons. For many individuals, however, organizing and storing their necessities can be a complete mess. More often than not, most individuals spend a quarter of their time rummaging through their gear to find what they need and go through yet another reorganization process to make practical sense of their belongings. Making trips back and forth to a car or house to gather and pack items can be incredibly inconvenient, stressful, and frustrating. There have been no products available as original equipment or as an aftermarket to address this problem.

An apparatus to simplify the process of packing, organizing and storing necessities when leaving home. There have been no products available as original equipment or as an aftermarket to address this problem either.

There exists a need for a device such as the One Trip Module Dolly that is not being met by any known or disclosed device or system of present.

### SUMMARY OF THE INVENTION

The main purpose of the OneTrip Module is to provide users with a high performance, carriage module with a pullout cooler, pullout storage compartments and a multi-purpose dolly with all terrain wheels.

The disclosure includes stackable boxes having an inside accessible via a front of each of the plurality of stackable boxes having a width and a combined height thereof. The disclosure also includes a folding tray configured to support the plurality of stackable boxes, the folding tray having a hinge on a width thereof. The disclosure additionally includes a telescopic adjustable height handle attached to the folding tray hinge and configured to the combined height of the plurality of stackable boxes. The disclosure further includes a pair of retractable wheels configured to support the folding tray hinge and adjust to the width of the plurality of stackable boxes.

### BRIEF DESCRIPTION OF THE DRAWINGS

FIG. 1 is a front elevational view of the One Trip Module Dolly apparatus in accordance with an embodiment of the present disclosure.

FIG. 2 is a front elevational view of the One Trip Module Dolly apparatus in accordance with an embodiment of the present disclosure.

FIG. 3 is a front elevational view of the One Trip Module Dolly apparatus in accordance with an embodiment of the present disclosure.

FIG. 4 is a front elevational view of the One Trip Module Dolly apparatus in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

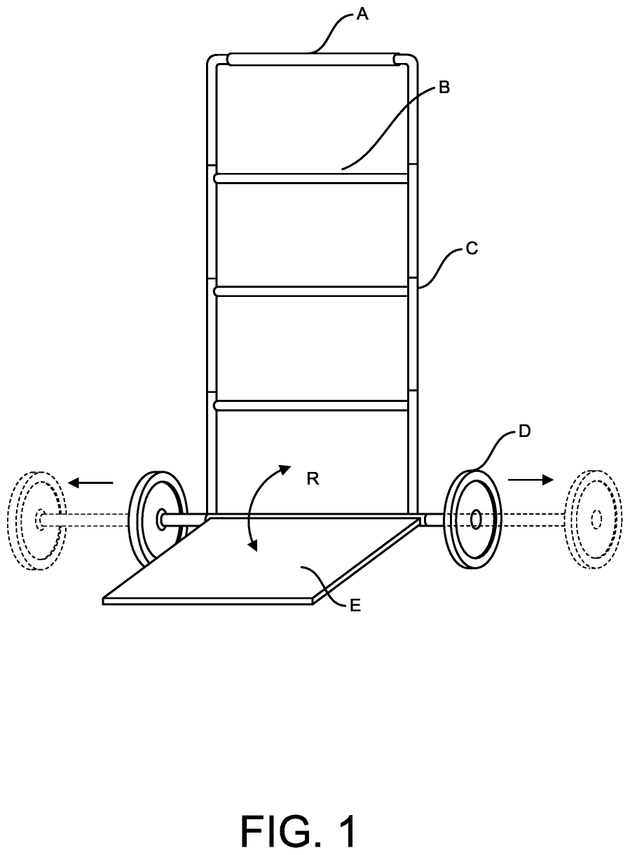

FIG. 1 is a front elevational view of the One Trip Module Dolly showing: Pull handle referenced as A., Ancillary handles referenced as B., Telescopic adjustable height handle referenced as C., Retractable wheels to adjust width referenced as D., Folding tray referenced as E., and a folding angle R in accordance with an embodiment of the present disclosure.

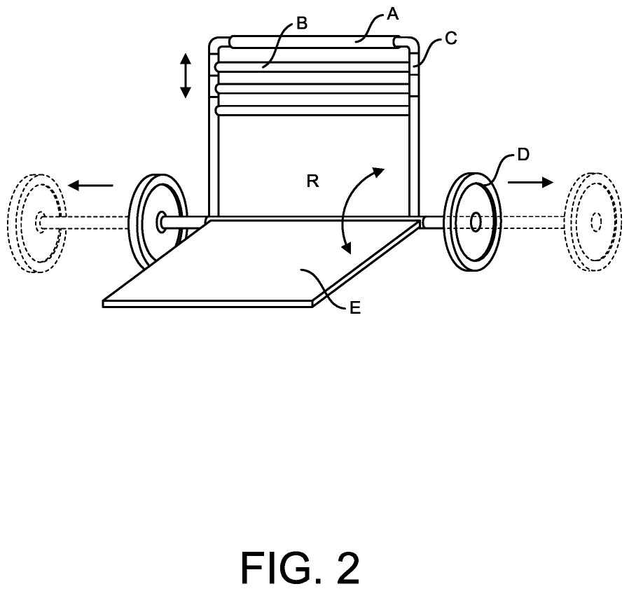

FIG. 2 is a front elevational view of the One Trip Module Dolly showing: Pull handle referenced as A., Adjustable dolly referenced as B., Telescopic adjustable height handle referenced as C., Retractable wheels to adjust width referenced as D., Folding tray referenced as E and a folding angle R in accordance with an embodiment of the present disclosure.

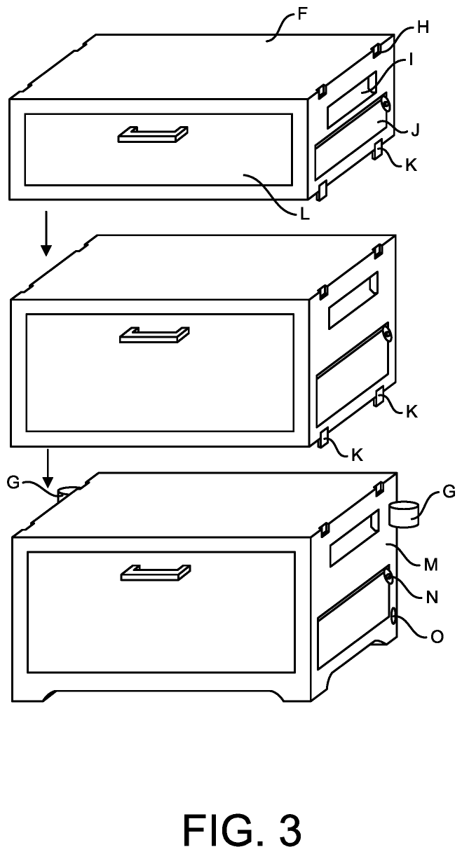

FIG. 3 is a front elevational view of the One Trip Module Dolly showing: Stackable box/compartment referenced as F., Retractable cup holder made of durable stretchy material referenced as G., Latch groove referenced as H., Side handle referenced as I., Weather proof zipper pocket referenced as J., Latch referenced as K., Pull out locking drawer referenced as L., Cooler/ice box base compartment referenced as M., Bottle opener referenced as N., Drain plug referenced as O in accordance with an embodiment of the present disclosure.

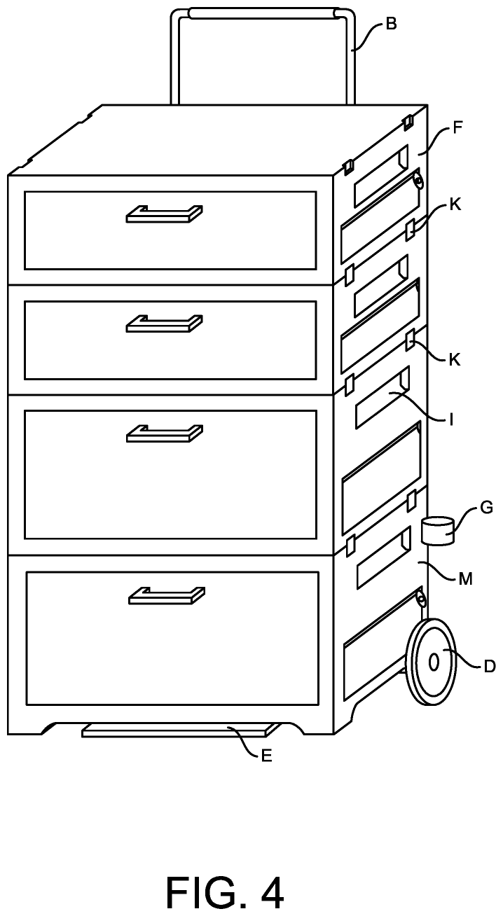

FIG. 4 is a front elevational view of the One Trip Module Dolly showing: Adjustable dolly referenced as B., Retractable wheels to adjust width referenced as D., Folding tray referenced as E., Stackable box/compartment referenced as F., Cooler/ice box base compartment referenced as M., in accordance with an embodiment of the present disclosure.

The present disclosed One Trip Module Dolly, also known as “OneTrip Module”, introduces a novel highly portable dolly that ensures individuals do not spend the bulk of their trip unpacking, repacking and making numerous stops to organize their materials. This innovative, multi-functional, product enable them to store all their items in one convenient storing carriage and is the perfect alternative to modern tool boxes, coolers, wagons, and other different types of carts. The OneTrip Module supports up to 250 lbs. and can be simply stacked and adjusted based on user preferences. The user can choose from the wide variety of storage compartments available such as the cooler and pullout locking drawer and securely latch them on-top of each unit for quick and effective transport. This in return allows users to add as many or as little storage compartments to the dolly to increase functionality as well as save time and space. The OneTrip Module may be necessary for all individuals who seek to have a highly functional, adjustable, and moveable storage unit.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A dolly comprising:
a plurality of stackable boxes having an inside accessible via a front of each of the plurality of stackable boxes having a width and a combined height thereof;
a folding tray configured to support the plurality of stackable boxes, the folding tray having a hinge on a width thereof;
a telescopic adjustable height handle attached to the folding tray hinge and configured to the combined height of the plurality of stackable boxes;
a pair of retractable wheels configured to support the folding tray hinge and adjust to the width of the plurality of stackable boxes.

2. The dolly of claim 1, further comprising a plurality of ancillary handles attached to the telescopic adjustable height handle.

3. The dolly of claim 1, wherein the front of each of the plurality of stackable boxes further comprises a pull out locking drawer.

4. The dolly of claim 1, wherein the pair of retractable wheels comprises concentric axles each configured to the hinge width.

5. The dolly of claim 1, further comprising a retractable cup holder made of a stretchy material.

6. The dolly of claim 1, further comprising a latch groove in a top of each of the plurality of stackable boxes.

7. The dolly of claim 1, further comprising a latch in a bottom of each of the plurality of stackable boxes.

8. The dolly of claim 1, further comprising a latch groove in a top of each of the plurality of stackable boxes and a complementary latch in a bottom of each thereof.

9. The dolly of claim 1, further comprising a pair of side handle indents in each of the plurality of stackable boxes.

10. The dolly of claim 1, wherein the plurality of stackable boxes comprises a base box configured as an insulated cooler.

11. The dolly of claim 1, further comprising a weather proof zipper pocket attached to one of the plurality of stackable boxes.

12. The dolly of claim 1, further comprising a bottle opener device attached to one of the plurality of stackable boxes.

13. The dolly of claim 1, wherein the folding tray comprises a latch groove in a top thereof.

14. The dolly of claim 1, wherein the folding tray comprises a latch groove in a top thereof and a base box of the plurality of stackable boxes comprises a complementary latch in a bottom thereof.

15. The dolly of claim 1, wherein the pair of retractable wheels comprise lateral locks configured to lock to a width of the plurality of stackable boxes plus a predetermined operating tolerance.

16. The dolly of claim 1, wherein the telescopic adjustable height handle further adjusts to a height equal to the combined height of the plurality of stackable boxes plus a predetermined handle tolerance.

17. The dolly of claim 1, wherein a number of the plurality of stackable boxes is three.

18. The dolly of claim 1, wherein the hinge is limited to an angle less than one hundred and eighty degrees by a hinge boss.

19. The dolly of claim 1, further comprising a spring configured to apply a folding force to the folding tray against the telescoping adjustable height handle.

20. The dolly of claim 1, further comprising an ancillary handle for each of the plurality of stackable boxes.
